(19) United States
(12) Patent Application Publication
(10) Pub. No.: US 2013/0042493 A1
(43) Pub. Date: Feb. 21, 2013

(54) ORGANIC WASTE DRYING APPARATUS

(71) Applicant: Dong-Wan Lee, Daegu (KR)

(72) Inventor: Dong-Wan Lee, Daegu (KR)

(73) Assignee: ENBIOCONS CO., LTD, Seoul (KR)

(21) Appl. No.: 13/695,618

(22) PCT Filed: Apr. 30, 2010
(86) PCT No.: PCT/KR2010/002765

§ 371 Date: Oct. 31, 2012

(51) Int. Cl. F26B 11/02

(52) U.S. Cl. 34/108

(57) ABSTRACT

An apparatus for drying organic waste dries and pulverizes organic waste, such as sewage sludge generated at a sewage pipe and a sewage treatment plant, various hydrous sludge waste, and food waste. The apparatus includes a drying drum rotatably provided on a base, a supply unit and a discharge pipe respectively provided at sealing caps for sealing front and rear sides of the drying drum, first and second pulverizing rotational blades driven by rotation axes provided at the front portion in the drying drum in a lengthwise direction thereof, an auxiliary pulverizing rotation blade driven by a rotation axis provided at the rear portion in the drying drum in a lengthwise direction thereof, a first opening portion and a first sealing member for discharging fine dried powder generated in a drying process, a second opening portion and a second sealing member for discharging completely dried organic waste, and a drying burner for blowing hot wind into the drying drum.

### CROSS-REFERENCE TO RELATED PATENT APPLICATIONS

### BACKGROUND OF THE INVENTION

1. Field of the Invention

The present invention relates to an apparatus for drying organic waste, and more particularly, to an apparatus for drying organic waste which simultaneously dries and pulverizes an object by performing a combined treatment of organic waste, such as sewage sludge generated at a sewage pipe and a sewage treatment plant, various hydrous sludge waste, and food waste, thereby improving drying efficiency and also reducing the volume and moisture content of the object to be dried.

2. Description of the Related Art

The treatment of organic waste, such as sewage sludge generated at a sewage treatment plant, various hydrous sludge wastes, and food waste, is very delicate. Conventionally, the sludge is treated by a method, such as ocean dumping or incineration.

However, since the London Dumping Convention strictly restricts ocean dumping of organic waste as of 2012, a land-treatment of organic waste is needed. A landfill may be considered as one of the land-treatments of organic waste. When organic waste needs to directly be buried in the ground, not only problems regarding the volume and a limited landfill site occur but also there is a considerable problem of environmental pollution.

Also, when organic waste is processed by using incineration, which is one of the land-treatment methods, since organic waste, such as sewage sludge, various hydrous sludge wastes, and food waste, not only includes a large amount of waste (an average moisture content of about 80% of organic waste) but also has a large volume, considerable costs for incineration are incurred. Even when organic waste is incinerated, a problem of treatment of a large amount of waste water is unavoidable. Furthermore, a large amount of toxic gas, such as dioxin, that is detrimental to the environment is generated during the incineration process of organic waste. Thus, an appropriate and efficient treatment of organic waste is strongly needed.

For efficient treatment of organic waste, drying equipment to reduce moisture content by drying organic waste has been introduced. Conventional drying equipment mainly dries organic waste by using an ignition source, such as oil or gas.

Such conventional drying equipment simply dries organic waste and thus it cannot be expected to uniformly and completely dry organic waste in a lump state. Furthermore, due to incomplete drying, the volume and the moisture content of organic waste may not be sufficiently reduced.

### SUMMARY OF THE INVENTION

To address the general problems generated in the conventional treatment of organic waste, the present invention provides an apparatus for drying organic waste which simultaneously dries and pulverizes organic waste, such as various sludge waste and food waste including a large amount of moisture, so that dried organic waste may be recycled in a variety of fields by improving a drying efficiency of organic waste and lowering moisture content of the organic waste under 10%, and also the volume and the moisture content of the organic waste are reduced and the amount of organic waste to be treated is increased within a limited space.

According to an aspect of the present invention, an apparatus for drying organic waste includes a drying drum rotatably provided on a base, a supply unit and a discharge pipe respectively provided at sealing caps for sealing front and rear sides of the drying drum, first and second pulverizing rotational blades driven by rotation axes provided at the front portion in the drying drum in a lengthwise direction thereof, an auxiliary pulverizing rotation blade driven by a rotation axis provided at the rear portion in the drying drum in a lengthwise direction thereof, a first opening portion and a first sealing member for discharging fine dried powder generated in a drying process, a second opening portion and a second sealing member for discharging completely dried organic waste, and a drying burner for blowing hot wind into the drying drum.

### BRIEF DESCRIPTION OF THE DRAWINGS

The above and other features and advantages of the present invention will become more apparent by describing in detail exemplary embodiments thereof with reference to the attached drawings in which:

FIG. 1 is a front view schematically illustrating an apparatus for drying organic waste according to an embodiment of the present invention;

FIG. 2 is a cross-sectional view schematically illustrating the inner structure of the apparatus for drying organic waste according to an embodiment of the present invention;

FIG. 3 is a reference cross-sectional view schematically illustrating that a drying drum and first and second pulverizing rotational blades are provided according to an embodiment of the present invention;

FIG. 4 is a reference cross-sectional view schematically illustrating that a drying drum and first and second pulverizing rotational blades are operated according to an embodiment of the present invention;

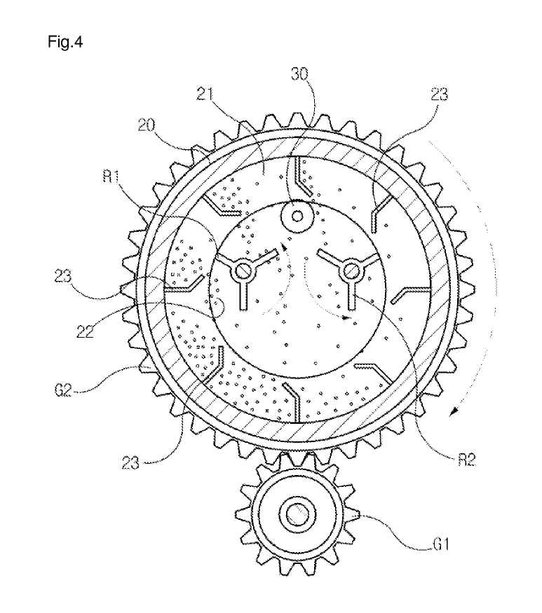

FIG. 5 is a reference cross-sectional view schematically illustrating that a first opening portion and a first sealing member are provided according to an embodiment of the present invention; and

FIG. 6 is a reference cross-sectional view schematically illustrating that a second opening portion and a second sealing member are provided according to an embodiment of the present invention.

### DETAILED DESCRIPTION OF THE INVENTION

The attached drawings for illustrating exemplary embodiments of the present invention are referred to in order to gain a sufficient understanding of the present invention, the merits thereof, and the objectives accomplished by the implementation of the present invention. Hereinafter, the present invention will be described in detail by explaining exemplary embodiments of the invention with reference to the attached drawings. Like reference numerals in the drawings denote like elements.

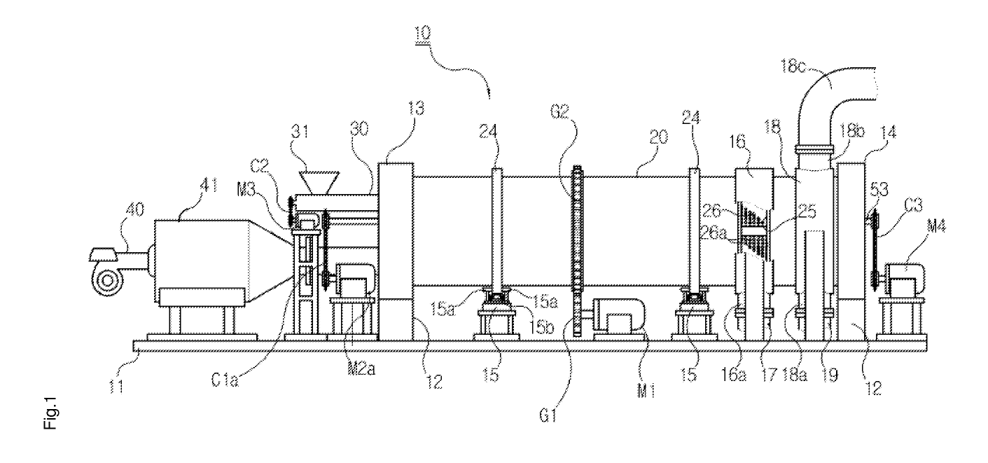

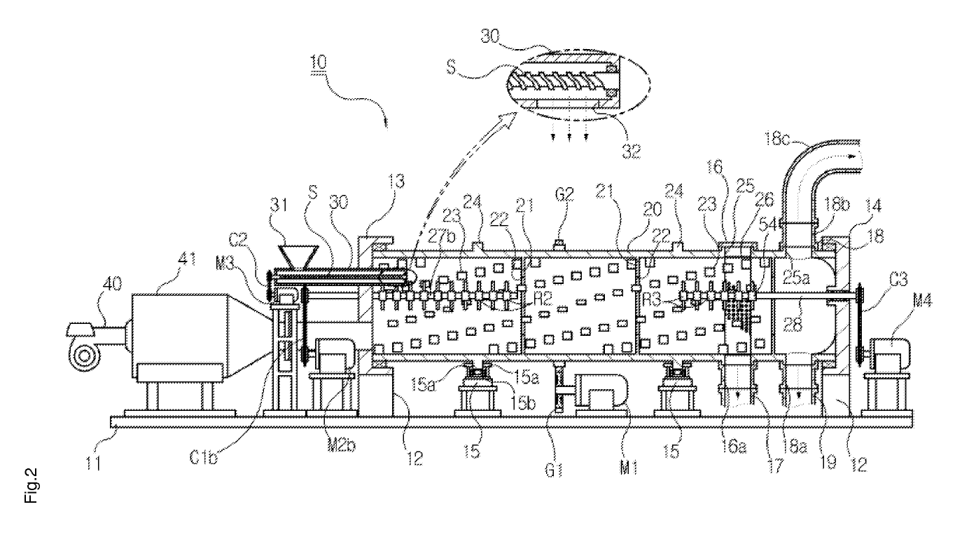

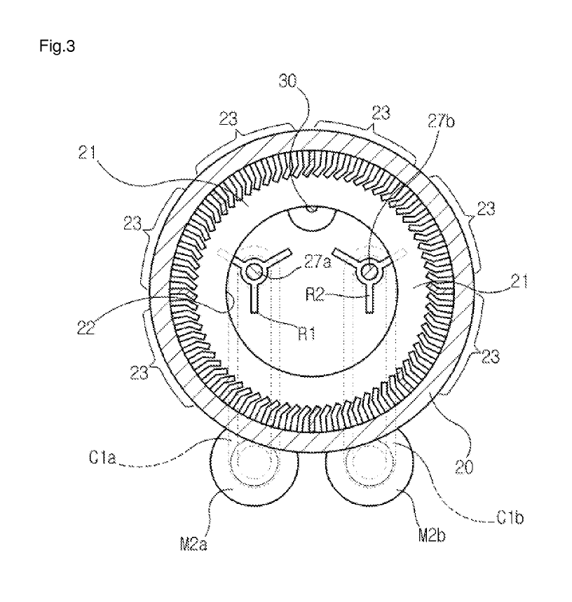

FIG. 1 is a front view schematically illustrating a drying apparatus 10 according to an embodiment of the present invention. FIGS. 2 and 3 are cross-sectional views schematically illustrating the inner structure of the drying apparatus 10 of FIG. 1

Referring to FIGS. 1 through 3, a plurality of support members 12 are provided on a base 11 at a predetermined interval. Front and rear sealing caps 13 and 14 are fixed and provided corresponding to the support members 12. A drying drum 20 is rotatably provided between the front and rear sealing caps 13 and 14. A rotating gear G2 is provided on an outer circumferential surface of the drying drum 20. The rotating gear G2 is engaged with a drive gear G1 that is driven by a drive motor M1 provided on the base 11. Thus, the drying drum 20 is rotated by the driving of the drive motor Ml.

The drying drum 20 is installed to be inclined lower toward the rear side. The drying drum 20 is maintained at an inclination angle of about 1.5° to 2° so that dried sludge may naturally slide toward the rear side. The reason for limiting the inclination of the drying drum 20 is because when the inclination angle is increased, eccentric load occurs on equipment and thus a drive unit may overwork. Also, the drying drum 20 may be driven by the drive motor M1 at a speed of 2 revolutions per minute.

Two rotation axes 27a and 27b having predetermined lengths are provided at the front side in the drying drum 20. First and second pulverizing rotational blades R1 and R2 are axially provided respectively on the rotation axes 27a and 27b. The rotation axes 27a and 27b are respectively coupled to rotation axes driving motors M2a and M2b via drive transfer units C1a and C1b such as chains and sprockets, to rotate the rotation axes 27a and 27b. A plurality of rows of transfer buckets 23 are spirally attached or provided on an inner wall surface of the drying drum 20. Each of the transfer buckets 23 is cut at a uniform interval so that the transfer buckets 23 may form a combination of a plurality of shovel plates.

The installation length of the first and second pulverizing rotational blades R1 and R2 that are respectively and axially provided on the rotation axes 27a and 27b does not exceed ⅓ of the total length of the drying drum 20. The rotation axes 27a and 27b may be rotated at a high speed of about 350 rpm by the rotation axes driving motors M2a and M2b, respectively. The rotation axes 27a and 27b may be driven in a direction opposite to the driving direction of the drying drum 20.

A rotation support member 24 having an O-ring shape is provided on an outer wall of the drying drum 20. A rotation support unit 15, including a support roller 15a for supporting a lateral surface of the rotation support member 24 and a support roller 15b for supporting an outer surface of the rotation support member 24, is provided on the base 11. Thus, the drying drum 20 may be stably rotated by the rotation support member 24.

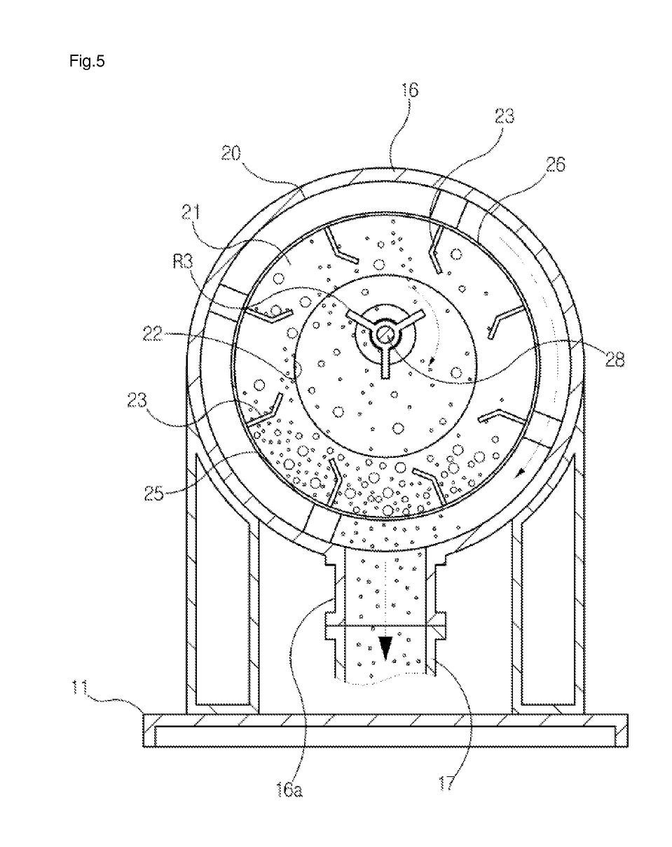

A plurality of disc-type partition members 21 are provided inside the drying drum 20. A through-hole 22 is formed in each of the partition members 21 so that the interior of the drying drum 20 may communicate with the through-hole 22. A first opening portion 25 is formed in front of one of the partition members 21 located at the rearmost side of the drying drum 20. A discharge member 26 having a plurality of fine discharge holes 26a is provided in the first opening portion 25. A first sealing member 16 having an O-ring shape is provided outside the first opening portion 25 to seal the first opening portion 25. A first discharge hole 16a is provided at the bottom of the first sealing member 16. A first discharge pipe 17 is provided at the first discharge hole 16a. Thus, fine powder generated during the organic waste drying process may be discharged through the fine discharge holes 26a, the first opening portion 25, the first discharge hole 16a, and the first discharge pipe 17 in this order (refer to FIG. 5).

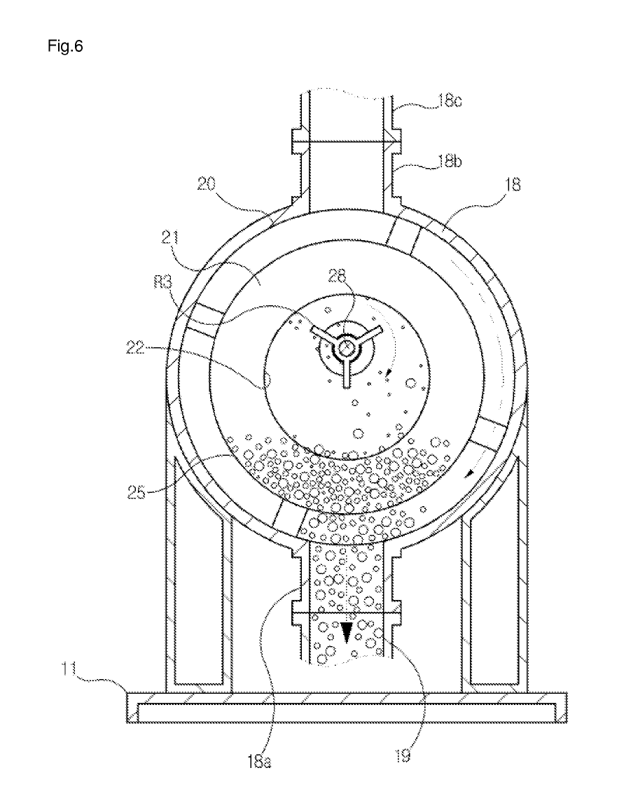

A second opening portion 25a is formed at the rear of one of the partition members 21 located at the rearmost side of the drying drum 20. A second sealing member 18 having an O-ring shape is provided outside the second opening portion 25a to seal the second opening portion 25a. A second discharge hole 18a is provided at the bottom of the second sealing member 18. A second discharge pipe 19 is provided at the second discharge hole 18a. Thus, the organic waste that is completely dried may be discharged through the second opening portion 25a, the discharge hole 16a, and the discharge pipe 17 in this order. An exhaust pipe 18c is provided at a third discharge hole 18b that is provided at the topside of the second sealing member 18 so that a bad smell and heat generated during the process of drying organic waste may be exhausted (refer to FIG. 6).

An auxiliary rotation axis 28 having a predetermined length is provided at the rear side in the drying drum 20. A plurality of auxiliary pulverizing rotational blades R3 are axially provided on the auxiliary rotation axis 28. The auxiliary rotation axis 28 is coupled to a rotation axis driving motor M4 via a drive transfer unit C3, such as chains and sprockets, to rotate the rotation axes 27a and 27b. The installation length of the auxiliary pulverizing rotational blade R3 does not exceed ⅓ of the total length of the drying drum 20.

A supply unit 30 having an input hopper 31 and a discharge opening 32 is provided at the front sealing cap 13. The discharge opening 32 is disposed at the front end portion in the drying drum 20. A supply screw S is provided inside the supply unit 30 so that a regular amount of sludge may be input. The supply screw S and a supply motor M3 are coupled to each other via a drive transfer unit C2, such as chains and sprockets, to rotate the supply screw S. A burner 40 is provided at one side of the front sealing cap 13 so that hot wind may be blown toward the inside of the drying drum 20.

In the present invention configured as above, when the drying apparatus 10 is driven and various sludge or pulverized food waste is input through the input hopper 31 of the supply unit 30, the sludge or food waste is forcibly transferred by the driving of the supply screw S to the inside of the drying drum 20 through the discharge opening 32. Since the supply of the sludge or food waste is performed by a screw method, a regular amount of sludge or food waste may always be input and the input amount may also be controlled.

The sludge or food waste supplied into the drying drum 20 through the discharge opening 32 is lifted by the transfer buckets 23 having a shape of a shovel plate and formed on the inner wall surface of the drying drum 20 that is rotated. Then, the lifted sludge or food waste falls down at the top position in the drying drum 20 to be hit and pulverized by the first and second pulverizing rotational blades R1 and R2 and the auxiliary pulverizing rotational blade R3 that are rotated at a high speed. The sludge or food waste in a pulverized state continues to be lifted and fall down. In doing so, since hot wind is blown by the burner 40 into the inside of the drying drum 20, the sludge or foot waste may be uniformly and quickly driven.

In other words, in the present invention, since the sludge or food waste is pulverized, slides downward, and is dried, the volume thereof may be reduced and the drying may be uniformly and quickly performed.

Also, in the present invention, the sludge or food waste is pulverized by the first and second pulverizing rotational blades R1 and R2 and the auxiliary pulverizing rotational blade R3 that are rotated at a high speed by rotating the rotation axes 27a and 27b and the auxiliary rotation axis 28 at a high speed while lowering the rotation speed of the drying drum 20, and thus an efficiency of pulverization may be improved. Also, since the inside of the drying drum 20 is sectioned by the disc-type partition members 21, organic waste may slide over the through-hole 22 of the partition member 21 and thus the flow of organic waste is delayed and the efficiency of pulverization and drying may be improved.

Also, in the present invention, fine powder in a completely dried state of waste generated during the drying and pulverization process of organic waste is primarily discharged through the first opening portion 25 and the first sealing member 16, and pulverized waste in thick grains further undergoes the drying and pulverization process and then is discharged through the second opening portion 25a and the second sealing member 18. Thus, not only the efficiency of pulverization may be improved, but also lowering of the efficiency of drying due to interposition of the fine powder between the pulverized waste in thick grains may be prevented. Further, since bad smell may be removed by transferring drying gas exhausted through the exhaust pipe 18c provided at the second sealing member 18 to deodorizing equipment, residents around a facility may not be affected by the bad smell. Further, since the drying gas, regardless of whether or not its bad smell is removed, used for drying is collected through the exhaust pipe 18c and then decay heat of the drying gas is used, a more efficient operation of the drying apparatus 10 may be possible.

According to the present invention, sludge is gradually transferred backward by the spiral transfer buckets 23 provided on the inner wall surface of the drying drum 20. Since the drying drum 20 is installed to be inclined lower toward the rear side, the sludge or food waste after the pulverization and drying process may be naturally transferred and discharged. The moisture content of the sludge or food waste to be discharged may be lowered under about 10%.

As described above, the apparatus for drying organic waste according to the present invention may perform a combined treatment of organic waste, such as various hydrous sludge waste and food waste. Since organic waste in a lump state is broken and dried during the drying process, uniform and complete drying may be achieved. The dried organic waste may be recycled in a variety of fields, such as auxiliary fuel for a thermal power plant. Also, not only moisture content but also the volume of the dried organic waste may be reduced. Thus, the waste water problem may be solved and incineration costs may be much reduced. Even when the organic waste is landfilled, environmental pollution due to waste water may be reduced and a limited landfill site problem may be solved.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. An apparatus for drying organic waste, the apparatus comprising:
a plurality of support members provided on a base at a predetermined interval;
front and rear sealing caps fixed and provided corresponding to the support members;
a drying drum rotatably provided between the front and rear sealing caps, the drying drum being installed to be inclined lower toward a rear side and maintained at an inclination angle of about 1.5° to 2°;
a drive motor coupled to the drying drum via a drive gear and a rotating gear to rotate and drive the drying drum;
a plurality of rows of transfer buckets spirally attached or provided on an inner wall surface of the drying drum, each of the transfer buckets being cut at a uniform interval to form a combination of a plurality of shovel plates;
a supply unit having an input hopper and a discharge opening provided at the front sealing cap, the discharge opening being disposed at a front end portion in the drying drum;
a supply screw provided inside the supply unit and a supply motor coupled to each other via a drive transfer unit, to rotate the supply screw; and
a burner provided at one side of the front sealing cap so that hot wind is blown toward the inside of the drying drum,
wherein two rotation axes are provided at a front side of the drying drum and first and second pulverizing rotational blades are respectively and axially provided on the rotation axes, and the rotation axes and the rotation axes driving motors are coupled via a drive transfer unit, to rotate the rotation axes,
wherein an auxiliary rotation axis is provided at the rear side in the drying drum and a plurality of auxiliary pulverizing rotational blades are axially provided on the auxiliary rotation axis, and the auxiliary rotation axis and a rotation axis drive motor are coupled to each other via a drive transfer unit, to rotate the auxiliary rotation axis,
wherein a through-hole is formed in each of a plurality of partition members provided in the drying drum so that the interior of the drying drum communicates with the through-hole, a first opening portion is formed in front of one of the partition members located at the rearmost side of the drying drum and a discharge member having a plurality of fine discharge holes is provided in the first opening portion, a first sealing member having an O-ring shape is provided outside the first opening portion to seal the first opening portion, and a first discharge hole is provided at the bottom of the first sealing member and a first discharge pipe is provided at the first discharge hole, thereby discharging fine powder generated during the organic waste drying process,
wherein a second opening portion is formed at the rear of one of the partition members located at the rearmost side of the drying drum and a second sealing member having an O-ring shape is provided outside the second opening portion to seal the second opening portion, a second discharge hole is provided at the bottom of the second sealing member and a second discharge pipe is provided at the second discharge hole, the organic waste that is completely dried is discharged through the second discharge pipe, and an exhaust pipe is provided at a third discharge hole that is provided at the topside of the second sealing member, thereby discharging a bad smell and heat generated during the organic waste drying process.
